(19) United States
(12) Patent Application Publication
(10) Pub. No.: US 2020/0262065 A1
(43) Pub. Date: Aug. 20, 2020

(54) METHOD OF CLOSED-LOOP POINT TO POINT ROBOT PATH PLANNING BY ONLINE CORRECTION AND ALIGNMENT VIA A DUAL CAMERA VISION SYSTEM

(71) Applicant: InTune Products LLC, Webster, NY (US)

(72) Inventors: Mostafa Ghobadi, Webster, NY (US); Aliakbar Alamdari, Webster, NY (US)

(21) Appl. No.: 16/791,165

(22) Filed: Feb. 14, 2020

Related U.S. Application Data
(60) Provisional application No. 62/805,574, filed on Feb. 14, 2019.

(51) Int. Cl. B25J 9/16; B25J 9/02

(52) U.S. Cl. CPC B25J 9/1664; B25J 9/1612; B25J 9/1697; B25J 9/026

(57) ABSTRACT

A method for point-to-point path planning of a manipulator robot with up to 6 degrees-of-freedom via a dual vision system aims at generating a rest-rest path and corrects it with a high precision through closed-loop pick and place path planning. The path is corrected and aligned with the desired path as soon as different visual feedbacks such as the position and orientation of the pick nests, the placement nests, and the workpiece (part) are observed via the dual vision system. The introduced path planning method is a comprehensive online approach that benefits from: (i) An advantageous path definition based on multiple coordinate systems, (ii) An online path planner with three correction procedures that corrects the pose of the workpiece with respect to the robot, to the desired path and to the placement nest.

### RELATIONSHIP TO OTHER APPLICATIONS AND PATENTS

The present application claims the benefit of U.S. Provisional Patent Application No. 62/805,574, filed Feb. 14, 2019, which is hereby incorporated by reference in its entirety.

### FIELD OF THE INVENTION

This manuscript presents a method for the point-to-point path planning of a manipulator robot with up to 6 degrees-of-freedom (DOF) via a dual vision system. The dual vision system is composed of two cameras; one is mounted on the end-effector of the robot looking downward, which is called DLC (downward looking camera), and the other one is fixed somewhere on the base of the robot looking upward, which is called ULC (upward looking camera). The proposed method aims at generating a rest-rest path and correcting it with a high precision through closed-loop pick and place path planning, where the path is corrected and aligned with the desired path as soon as different visual feedbacks such as the position and orientation of the pick nests, the placement nests, and the workpiece (part) are observed via the dual vision system.

### BACKGROUND OF THE INVENTION

Robotic Accuracy Improvement System is one of the main concerns of many robotic systems such as articulated 6-DOF arm and gantry robotic systems in wafer positioning and semiconductor industry. For example, articulated robots have a plurality of rotary joints and are typically powered by electric motors. In various applications, a load may be applied to the end effector which can unintentionally move the robot slightly. This slight movement can cause unintentionally moving the tool tip off of its desired location. The correction of robot end of tool is one of the main issues in industrial applications.

Robot motor encoders are coupled with a computing device to receive motion commands for actuating a motor of one of the joints of the robotic arm. Robot motor encoders may sense motion of the robot motor in unintentional move of the robot. However, the robot motor encoders cannot monitor the actual joint motion due to elasticity and other issues which the motor encoder cannot sense. Since the robot motor encoders do not sense this external joint movement, they cannot be accurately used to determine when a movement of the motor is required to correct the joint position. In U.S. Pat. No. 7,979,160, the authors provide a system and method for sensing and compensating for unintended joint movement of a robotic arm caused by application of a load on the robotic arm. The system comprises external encoders adapted for sensing movement of joints.

In U.S. Publication No. 2016/0136812 to Hosek et al. (Hosek), two-link arm robots with flexibility at join/link level are considered as the target system, where the target systems of the presented method in this manuscript is Cartesian gantry robots with a high rigidity. Hosek aims at correcting the end-effector of the robot based on estimation of possible deflections as an indispensable property of an arm robot with flexible mechanism, where these deflections are considered as the only source of inaccuracy. However, the proposed method is applicable to rigid gantry systems and has different goals than the method presented in Hosek, where the varying positions of the picking and placing nests with respect to the robot as well as varying position of the workpiece with respect to the picking nest is considered as a source of inaccuracy.

U.S. Pat. No. 8,768,513 to Cox et al. (Cox) aims at correcting the end-effector position to grab the workpiece as it was supposed to by alignment of the robot's end-effector with respect to the workpiece to compensate positional and orientational errors. The target systems in Cox are the multi-linkage robots. However, the method presented in Cox is not limited to correct the position and orientation of end-effector to grab the workpiece as it was supposed to and although this type of correction is considered as look before pick procedure but it is optional and it is not a necessary step to do, instead in the method presented here, the robot can skip this step and grab the workpiece as it is (knowing that the workpiece is guaranteed to be placed within a controlled range of pose with predefined accuracy values of position and orientation) and then the robot compensates the errors by simultaneous positional/rotational alignment of the workpiece with respect to the desired path as the errors is observed on-the-fly through Coverage Path Planning (CPP) procedure. The main advantage of the CPP procedure is that since the errors may stem from either the initial positioning of the workpiece or slippage of workpiece with respect to the end-effector during picking process, the CPP can compensate both type of errors. Furthermore, our method can additionally compensate the positioning errors of the placing nests with respect to the machine through Critical Path Node (CPN) procedure.

The application of end of tool correction and alignment in robotic systems is in the wafer positioning system and manufacturing of integrated circuits. A wafer positioning system determines the position of a wafer during processing by monitoring the position of the wafer transport robot as the robot transports the wafer by one or more position sensors. In U.S. Pat. No. 5,563,798, the wafer positioning system incorporates a transparent cover on the surface of the wafer handling chamber and two optical position sensors disposed on the surface of the transparent cover. At least two data points are measured to establish the wafer position. If the wafer is not at its nominal position, the position of the wafer transport robot is adjusted to compensate for the wafer misalignment.

### SUMMARY OF THE INVENTION

Here, it is assumed that the robot picks a workpiece located on the very top pick nest while the workpiece and the pick nest(s) can be seen via a DLC (downward looking camera), then the robot follows a predefined desired path while the workpiece can be seen, at some certain point in the middle of the path, via an ULC (upward looking camera), and finally it places the workpiece on the very top placement nest while the placement nest(s) can be seen via the DLC. It should be noted that the DLC is mounted next to the end-effector of the robot and moves as the robot moves but the ULC is fixed on the base of the machine (robot). The introduced path planning method is a comprehensive online approach that benefits from: (i) An advantageous path definition based on multiple coordinate systems, (ii) An online path planner with three correction procedures that corrects the pose of the workpiece with respect to the robot, to the desired path and to the placement nest.

The pose refers to the spatial position and orientation of a certain coordinate system attached to a specific location of an arbitrary physical component, where the pose of an object is always defined in relative to another pose. The poses are always represented by affine transformations in this manuscript, where the reference pose is called the World pose attached to the base of the machine (robot). The location of the very top pick/placement nest can be varying from one pick-and-place process to the next one, this location can vary with respect to a sequence of parent pick/placement nests which are located in-between the very top nest and the machine (robot) base.

As mentioned earlier, the robot picks a workpiece located on the very top pick nest, then the robot follows a predefined desired path while the workpiece can be seen at some certain point in the middle of the path via an ULC (upward looking camera), and finally it places the workpiece on the very top placement nest. The user needs to first define the beginning and ending poses (the spatial position and orientation) of the part with respect to the pick nest and the placement nest, where the part is supposed to be picked from at the beginning of motion and placed on at the end of motion, respectively. The user also defines the offsets of the immediate poses after picking and before placing poses. The cameras and robot are assumed calibrated with respect to world coordinate system that is used as the reference coordinate system to determine the pose of the rest of the objects. According to definition of different objects such as the nests and the part, the pose of each object is obtained either directly or through a sequence of transformations with respect to the world coordinate system.

This method not only provides a unified approach for any pick and place applications and facilitate the path planning process, but also introduces a unique way to define the path and plan the robot motion such that other uncertainties in the pose of objects will be taken care of automatically. One of the main applications that the proposed method is highly beneficial to is the fast pick and place process, where the part has a relatively inaccurate position but accurate enough to be grabbed and picked with a compliant gripper such as a vacuum gripper. To accelerate the process, instead of wasting a decent amount of time inspecting the accurate position of the part before picking, the pose of the part with respect to the robot will be corrected on-the-fly via ULC while the robot is traveling on top of the ULC. The other main application is auto-adjustment of the placing position by inspecting the placement nest via DLC in the meanwhile the robot is waiting for the new part being fed for the next pick and place procedure. Moreover, the proposed method minimizes the overall process time by introducing three correction procedures, Correct Before Picking (CBP), Correct After Picking (CAP), Correct Earlier than Placement (CEP), and then providing the flexibility for the user to custom the type of correction procedures required for a specific pick and place application.

### BRIEF DESCRIPTION OF THE DRAWINGS

FIG. 1 is a 3D model of a gantry robot suitable to be used to implement an embodiment of a method of the present invention;

FIG. 2 is a schematic view of a robot path and dual camera vision system in accordance with an aspect of the present invention;

FIG. 3 is a schematic view showing flexibly of workpiece poses using an embodiment of the system and method in accordance with an aspect of the present invention;

FIG. 4 is a schematic representation of an exemplary method in accordance with an aspect of the present invention using three pick and placement nests;

FIG. 5 is an exemplary flowchart of the exemplary method shown in FIG. 4; and

FIG. 6 is a table compiling the operations utilized within the exemplary method shown in FIGS. 4 and 5.

### DETAILED DESCRIPTION OF THE PREFERRED EMBODIMENTS

### System Description

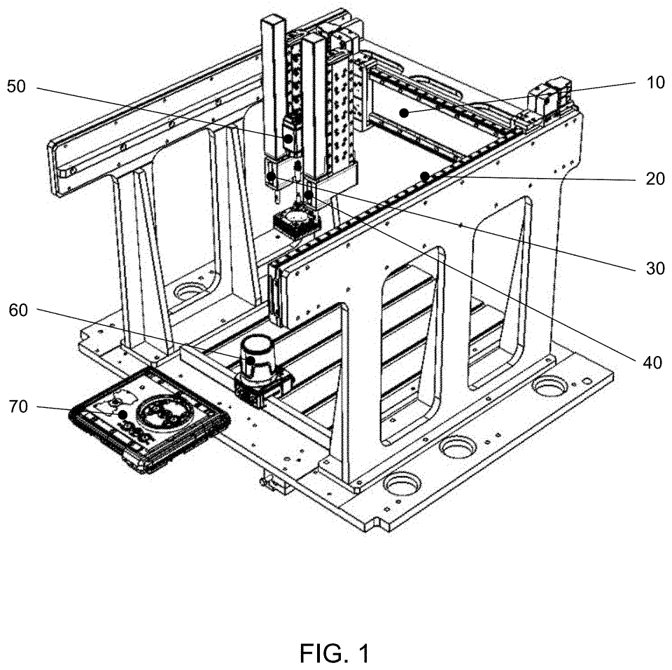

FIG. 1 shows the 3D model of the gantry robot used to implement the proposed method. As shown in FIG. 1, the robot has two end-effectors (tools) and equipped with a dual camera vision system, where the downward looking camera (DLC) is fixed to the end-effector of the robot and moves as the end-effector moves. The upward looking camera is though fixed to the base of the machine as shown in FIG. 1. The tools on the end-effectors are configurable and therefore one or both tools can be used for pick and place application by installing different grippers such as vacuum grippers.
[10] Robot X axis
[20] Robot Y axis
[30] Robot Z and Rotation axes—End Effector 1
[40] Robot Z and Rotation axes—End Effector 2
[50] Downward Looking Camera (DLC)
[60] Upward Looking Camera (ULC)
[70] Pick/Placement Nests and the Workpiece (Part)
   Convention Used to Represent the Pose of Objects and Transformation Between them

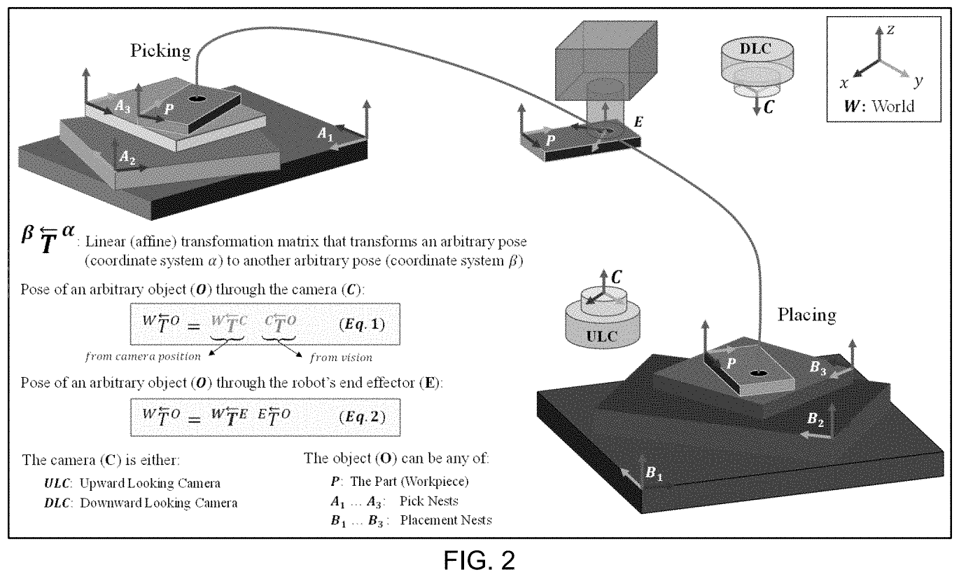

FIG. 2 illustrates the schematic of the robot path and the dual camera vision system. It also includes some basic definitions of the coordinate systems (poses of different physical components).

The pose of each object is uniquely represented by a certain coordinate system fixed to an object, where the origin of coordinate system is located at a predefined point on the object. A linear (affine) transformation ^{β} [symbol] ^{α} is used to transform from one pose (coordinate system α) to another one (coordinate system β):

$${T}^{β ← a} = [ \begin{matrix}{{R}^{β ← a}}_{3 \times 3} & {{d}^{β ← a}}_{3 \times 1} \\ {0}_{1 \times 3} & 1\end{matrix} ] \qquad ( 1 )$$

where ^{β} [symbol] _{3×3}^{α} and ^{β} [symbol] _{3×1}^{α} are respectively the rotation matrix and the translation vector that is used to transform from one pose (coordinate system α) to another pose (coordinate system β). This way, both the transformation from an object (α) to another object (β), and the pose of latter object (β) with respect to the former one (α), can be represented only by one transformation matrix (^{α} [symbol] ^{β}).
For example, in order to transform from pose α to γ, one can transform from pose α to β and then from β to γ:

^{γ} [symbol] ^{α}=^{γ} [symbol] ^{ββ} [symbol] ^{α} (2)

According to the property of the rotation matrix, one can find the inverse transformation using the following equation:

$${T}^{α ← β} = {( {T}^{β ← a} )}^{- 1} = [ \begin{matrix}{( {{R}^{β ← a}}_{3 \times 3} )}^{T} & - {( {{R}^{β ← a}}_{3 \times 3} )}^{T} ( {{d}^{β ← a}}_{3 \times 1} ) \\ {0}_{1 \times 3} & 1\end{matrix} ] \qquad ( 3 )$$

where ▪⁻¹ and ▪^{T} denote the inverse and the transpose of a matrix, respectively.

The world coordinate system (W), the camera coordinate system (C), and the end-effector coordinate system (E) are three most useful poses used in the path planning, where W is the main reference coordinate system fixed on the corner of the base of the robot, E represents the active end-effector of the robot and C represents either DLC or ULC.

A useful application of equation (2), is to obtain the pose of an arbitrary object (O) with respect to the world coordinate system through the camera once an object is observed via DLC or ULC as:

^{W} [symbol] ^{O}=^{W} [symbol] ^{CC} [symbol] ^{O} (4)

Another advantageous application of equation (2), is to obtain the pose of an arbitrary object (O) with respect to the world coordinate system through the end-effector, once the object needs to be picked by the active end-effector:

^{W} [symbol] ^{O}=^{W} [symbol] ^{EE} [symbol] ^{O} (5)

### An Advantageous Path Definition Based on Different Coordinate Systems

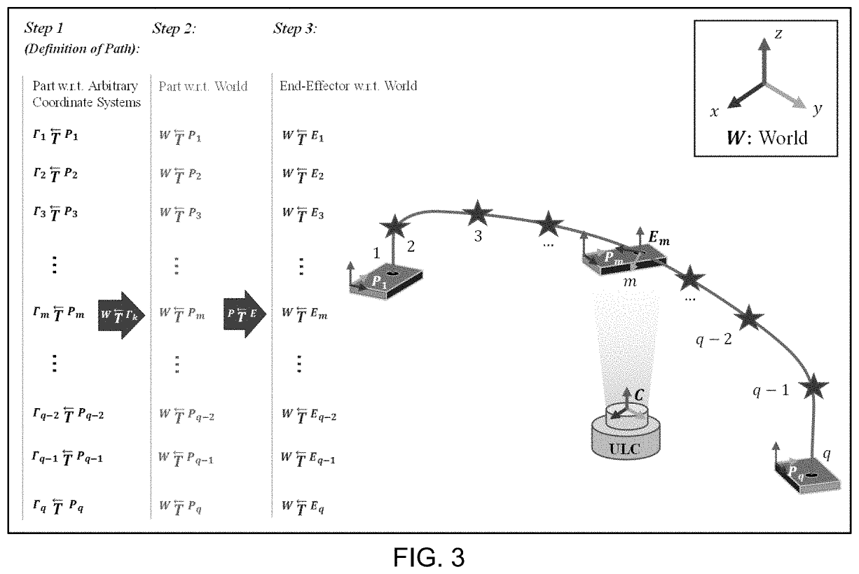

The proposed method is based on a specific convention to define the spatial trajectory for the pose (both the position and orientation) of the workpiece (part), which is called the path definition. This path is introduced as a sequence of q key points (poses) {^{Γ}^{₁} [symbol] ^{P}^{₁}, ^{Γ}^{₂} [symbol] ^{P}^{₂}, . . . , ^{Γ}^{ₘ} [symbol] ^{P}^{ₘ}, . . . , ^{Γ}^{_{q−1}} [symbol] ^{P}^{_{q−1}}, ^{Γ}^{_{q}} [symbol] ^{P}^{_{q}}}, where each pose can be defined with respect to an arbitrary coordinate system. These arbitrary coordinate systems can be selected afterwards such that the time-to-time variations of the relative poses of the nests with respect to each other as well as the workpiece with respect to the robot will not entail any side effects on the values defined for the poses of the key points of the path. This advantageous property will be used afterwards for the online path planner. FIG. 3 shows how flexibly the poses of the workpiece can be defined on the path using this general approach; the user can define the pose of the part on the path at a certain moment like t=k, 1≤k≤q with respect to an arbitrary coordinate system, Γₖ, as ^{Γ}^{ₖ} [symbol] ^{P}^{ₖ}.

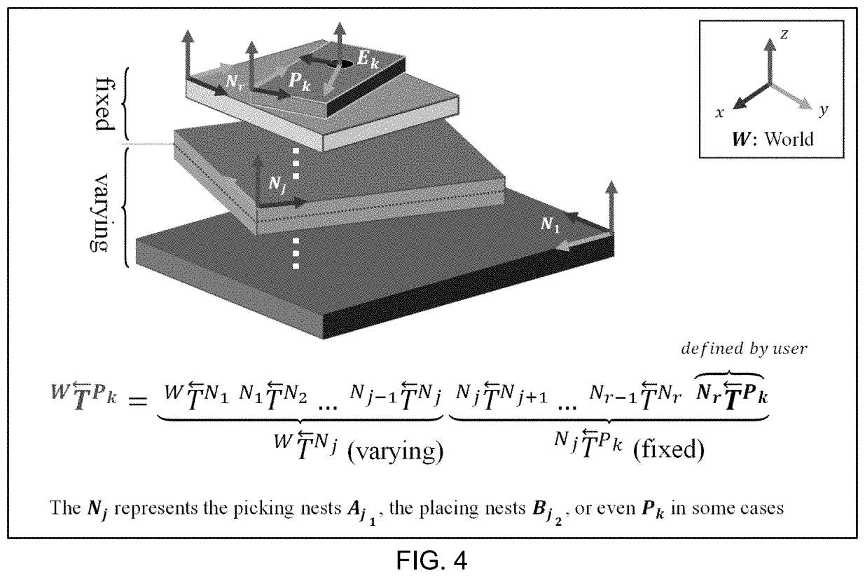

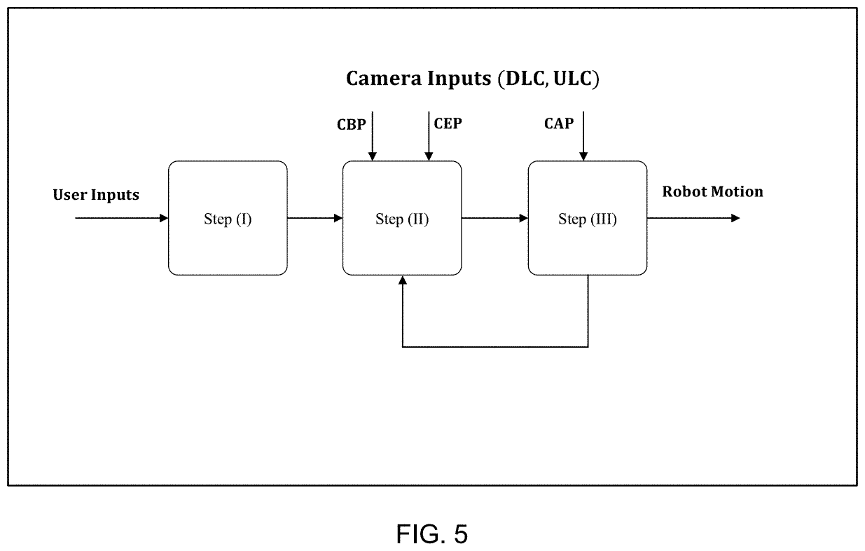

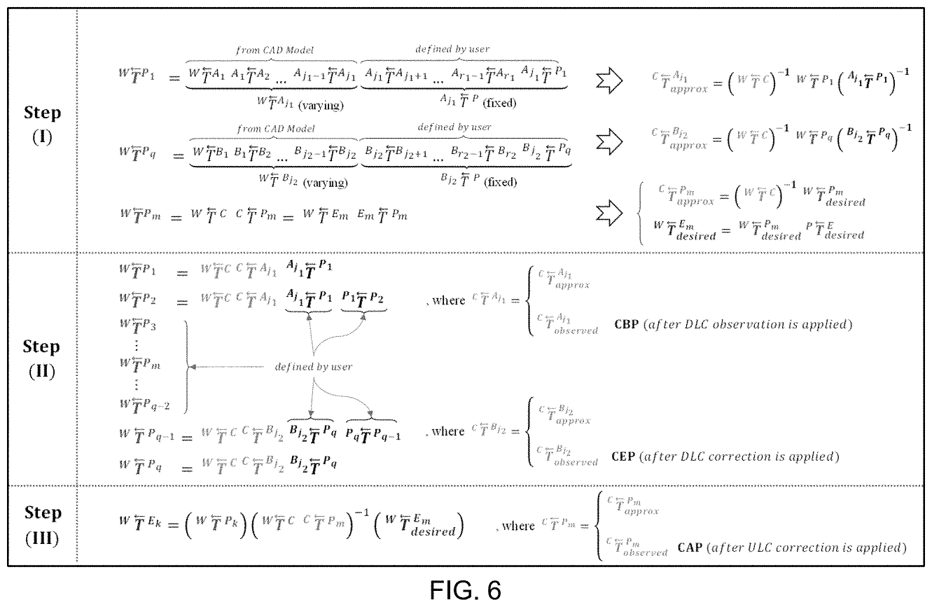

To provide a simple visualization, without loss of generality, only three pick and placement nests are considered in FIGS. 4-6. Generalizing the 3 pick and placement nests shown in FIG. 6 to r₁ pick nests (A₁, A₂, . . . , Aⱼ_{₁}, . . . , Aᵣ_{₁}₋₁, Aᵣ_{₁}) or r₂ placement nests (B₁, B₂, . . . , Bⱼ_{₁}, . . . , Bᵣ_{₁}₋₁, Bᵣ_{₁}), respectively, we can use the unified notations of FIG. 6, where r nest are defined as (N₁, N₂, . . . , Nⱼ, . . . , Nᵣ₋₁, Nᵣ) for both types of nests. For any specific application, the nests can be grouped into two groups with one overlapping member (Nⱼ): a) the Varying group (N₁, N₂, . . . , Nⱼ), and b) the Fixed group (N₁, Nᵣ₋₁, Nᵣ), where the relative poses between two consequent nests is not altering among the Fixed group and the values of these relative poses are known and determined with an acceptable accuracy, while such relative poses can alter among the Varying group.

A useful customization of this path definition will be used throughout the rest of manuscript hereafter, where the following assumptions are made to obtain it:
[1] The picking pose ^{Γ}^{₁} [symbol] ^{P}^{₁} (position and orientation) as the very first point of the path is defined with respect to the coordinate system which is attached to the pose-varying pick nest (Aⱼ_{₁}) as

$${}_{}^{{A}_{{j}_{1}}}{\overleftarrow{T}}{}_{}^{{P}_{1}} .$$

[2] The placing pose ^{Γ}^{_{q}} [symbol] ^{P}^{_{q}} the very last point of the path is defined with respect to the coordinate system which is attached to the last pose-varying placement nest (Bⱼ_{₂}) as

$${ }^{{B}_{{j}_{2}}} {\overleftarrow{T}}^{{P}_{q}} .$$

[3] The immediate pose that robot needs to plan to move to immediately either after the pick pose or before the placement pose, which respectively added to the path after the very first key point as the second key point ^{Γ}^{₂} [symbol] ^{P}^{₂} and before the very last key point as second last key point ^{Γ}^{_{q−1}} [symbol] ^{P}^{_{q−1}}, are easier for the user to be defined in terms of the approaching offset with respect to the first and last key points as ^{Γ}^{₁} [symbol] ^{P}^{₂} and ^{Γ}^{_{q}} [symbol] ^{P}^{_{q−1}}. Therefore, their poses with respect to the last Varying nests are obtained as follows:

$${ }^{{A}_{{j}_{1}}} {\overleftarrow{T}}^{{P}_{2}} {=}^{{A}_{{j}_{1}}} {\overleftarrow{T}}^{{P}_{1} } {}_{}^{{P}_{1}}{\overleftarrow{T}}{}_{}^{{P}_{2}} \\ \begin{matrix}{ }^{{B}_{{j}_{2}}} {\overleftarrow{T}}^{{P}_{q - 1}} {=}^{{B}_{{j}_{2}}} {\overleftarrow{T}}^{{P}_{q} } {}_{}^{{P}_{q}}{\overleftarrow{T}}{}_{}^{{P}_{q - 1}} & \end{matrix} \qquad ( 6 )$$

[4] Up to this step, the very first two key points at the beginning of the path as well as the very last two key points at the end of the path are defined. The rest of the key points on the path can be arbitrarily defined with respect to the world coordinate system, one of the pick and placement nests among the Fixed groups, the workpiece at the first or last key points, the cameras, or etc.
[5] In cases where the ULC is required to be used, the only requirement in the definition of the path is to assure that the workpiece can be seen via the ULC somewhere in the middle of the path at a speed lower than a predefined maximum speed. For example, for the middle point (t=m), the pose can be defined with respect to the ULC as ^{C}^{₁} [symbol] ^{P}^{ₘ}. The maximum speed is defined by the Vision System requirement such that the camera has enough time to properly capture a single-frame image from the workpiece's visual features.
[6] Another assumption made here is that, the position of the workpiece (part) with respect to the active end-effector of the robot is fixed, therefore the user can define ^{P} [symbol] ^{E}^{_{desired}} that represents the location on the part, where the robot is required to pick the part at, or in other words, ^{P} [symbol] ^{E}^{_{desired}} is the desired pose of the end-effector with respect to the part during pick and place process. It should be noted that although the robot would try to pick the part such that ^{P} [symbol] ^{E}^{_{desired}} is considered, there are some possible inaccuracy in the position of the object compared to theory, and also some slippage may occur when the part is being picked, and thus the value of the actual ^{P} [symbol] ^{E} would be most likely different from its desired value and needs to be corrected afterwards.
   Therefore, the path definition used by the online path planner throughout the next section will be defined as follows:

$${Path}_{desired} = {\{}^{{A}_{{j}_{1}}} {\overleftarrow{T}}^{{P}_{1}} , {}_{}^{{P}_{1}}{\overleftarrow{T}}{}_{}^{{P}_{2}} , {}_{}^{W}{\overleftarrow{T}}{}_{}^{{P}_{3}} , … , {}_{}^{W}{\overleftarrow{T}}{}_{}^{{P}_{m - 1}} , {}_{}^{C}{\overleftarrow{T}}{}_{}^{{P}_{m}} , {}_{}^{W}{\overleftarrow{T}}{}_{}^{{P}_{m + 1}} , … , {}_{}^{W}{\overleftarrow{T}}{}_{}^{{P}_{q - 2}} , {}_{}^{{P}_{q}}{\overleftarrow{T}}{}_{}^{{P}_{q - 1}} {,}^{{B}_{{j}_{2}}} {\overleftarrow{T}}^{{P}_{q}} \} \qquad ( 7 )$$

Online Path Planner with Three Correction Procedures

The proposed method get feedback from a dual camera vision system to correct the dynamic pose of the workpiece 1) with respect to the robot, 2) with respect to the desired pick-and-place path, and 3) with respect to the pose-varying placement nests in an online manner through three procedures:

1) Correct Before Pick (CBP): The online path planner via CBP procedure can correct the pose at which the end-effector of the robot picks the workpiece in the beginning of motion through DLC. In this procedure, the pose of the last varying pick nest (Aⱼ_{₁}) must be observed as

$${}_{ }^{C}{\overleftarrow{T}}{}_{ }^{{A}_{{j}_{1}}}$$

via DLC and then all poses that are dependent on this nest will be corrected accordingly. It should be noted that, after CBP the relative pose of the workpiece with respect to the robot is not always guaranteed to be determined due to possible slippage or other type of physical interaction between the workpiece and the robot gripper (end-effector). However, this possible undesired dislocation is often controllable inside a desired range with an acceptable accuracy for placement. Otherwise, this discrepancy can be corrected in the next procedure.

2) Correct After Pick (CAP): the online path planner via CAP procedure can correct the pose of the workpiece with respect to the desired path in the middle of the path through ULC. In this procedure, the pose of the workpiece (part) is observed as ^{C} [symbol] ^{P}^{ₘ} via ULC and the relative pose of the part with respect to the robot will be corrected accordingly. This procedure can be done only after the workpiece is picked and the motion is started, it is assumed that this is done at some point in the middle of the path, referred to as the middle point and indexed by the subscripted m. Since the workpiece would not be dislocated after it is picked, this correction procedure is used to align the pose of the workpiece on the path as expected and accordingly to correct the placement error that otherwise cannot be corrected.

3) Correct Earlier than Placement (CEP): the online path planner via CEP procedure can correct the pose of the workpiece with respect to the pose of placement nests through DLC. In this procedure, the pose of the last varying placement nest (Bⱼ_{₂}) must be observed as

$${}_{ }^{C}{\overleftarrow{T}}{}_{ }^{{B}_{{j}_{2}}}$$

via DLC and then all poses that are dependent on this nest will be corrected accordingly. The CEP procedure can be done either immediately before the placement or at any time earlier than placement for example before when the motion gets started and the part has not been fed to start the pick and place process. It should be noted that CEP must be done once the poses of the placement nests can be guaranteed afterwards to be not changing while the pick- and place process gets started and continues to be happening.

### Correction Procedures

The three correction procedures, CBP, CAP, and CEP, can be considered in two sections based on the camera used for correction.

1) Correction via DLC: To perform CBP and CEP procedures, [symbol] and [symbol] are assumed to be observed via the DLC, respectively. Using general notation of Nⱼ for nests Aⱼ_{₁} and Bⱼ_{₂}, one can obtain the pose of the nest through the camera using:

^{W} [symbol] ^{N}^{ⱼ}=^{W} [symbol] ^{CC} [symbol] ^{N}^{ⱼ} (8)

A similar equation can be written to obtain the pose of the part through the nest:

^{W} [symbol] ^{P}^{ₖ}=^{W} [symbol] ^{N}^{ⱼ}^{N}^{ⱼ} [symbol] ^{P}^{ₖ} (9)

One can obtain equation (10) by combine (8) and (9).

^{W} [symbol] ^{P}^{ₖ}=^{W} [symbol] ^{CC} [symbol] ^{N}^{ⱼ}^{N}^{ⱼ} [symbol] ^{P}^{ₖ} (10)

Equation (10) can be used as a general formula to obtain the pose of the workpiece (part) in world coordinate system, in which the camera observation is considered. However, the value of ^{C} [symbol] ^{N}^{ⱼ} is not always available. While the actual value of ^{C} [symbol] ^{N}^{ⱼ} will be available once the nest is observed via DLC as ^{C} [symbol] _{observed} ^{N}^{ⱼ}, it is required to be initially approximated as ^{C} [symbol] ₐₚₚᵣₒₓ^{N}^{ⱼ} using equation (11), which itself is resulted by (8).

^{C} [symbol] ₐₚₚᵣₒₓ^{N}^{ⱼ}=(^{W} [symbol] ^{C})^{-1W} [symbol] ^{N}^{ⱼ} (11)

In equation (11), ^{W} [symbol] ^{N}^{ⱼ} is obtained from initial estimation according to the robot CAD model.

2) Correction via ULC: To perform CAP procedure, ^{C} [symbol] ^{P}^{ₘ} is assumed to be observed via the ULC at the middle point (m^{th} moment) of the path. Therefore, one can obtain the pose of the part in world coordinate system using:

^{W} [symbol] ^{P}^{ₘ}=^{W} [symbol] ^{CC} [symbol] ^{P}^{ₘ} (12)

Moreover, the pose of the end-effector at the middle point is assumed to be ^{W} [symbol] ^{E}^{ₘ}, and thus the pose of the part can be obtained through the robot's end-effector using:

^{W} [symbol] ^{P}^{ₘ}=^{W} [symbol] ^{E}^{ₘ}^{E}^{ₘ} [symbol] ^{P}^{ₘ} (13)

Now, let's use equation (2) to obtain pose of end-effector in world coordinate system through the part at some arbitrary moment k:

^{W} [symbol] ^{E}^{ₖ}=^{W} [symbol] ^{P}^{ₖ}^{P}^{ₖ} [symbol] ^{E}^{ₖ} (14)

Since the pose of end-effector with respect to the part must be fixed during the pick and place, we can conclude that ^{P}^{ₖ} [symbol] ^{E}^{ₖ}=^{P}^{ₘ} [symbol] ^{E}^{ₘ}=^{P} [symbol] ^{E}, and therefore ^{P} [symbol] ^{E} can be written as equation (15) by combining (12) and (13).

^{P} [symbol] ^{E}=(^{W} [symbol] ^{CC} [symbol] ^{P}^{ₘ})⁻¹(^{W} [symbol] ^{E}^{ₘ}) (15)

Substituting ^{P}^{ₖ} [symbol] ^{E}^{ₖ} in (14) with ^{P} [symbol] ^{E} of (15), we obtain the general transformation of (16) for every k>m.

^{W} [symbol] ^{E}^{ₖ}=(^{W} [symbol] ^{P}^{ₖ})(^{W} [symbol] ^{CC} [symbol] ^{P}^{ₘ})⁻¹(^{W} [symbol] ^{E}^{ₘ}) (16),

where T m is obtained from the ULC observation (^{C} [symbol] _{observed}^{P}^{ₘ}), once the CAP procedure is performed. However, can be initially approximated using the desired value ^{C} [symbol] _{desired}^{P}^{ₘ} assigned by user in the path definition of (7). In the case where the middle point of the path is defined by p user with respect to the world coordinate system as ^{W} [symbol] ^{P}^{ₘ} instead of the camera, an initial approximation can be calculated by inversing (12) as:

^{C} [symbol] ₐₚₚᵣₒₓ^{P}^{ₘ}=(^{W} [symbol] ^{C})^{-1W} [symbol] ^{P}^{ₘ} (17)

Moreover, ^{W} [symbol] ^{E}^{ₘ} in equation (16) is obtained from (18), where the ^{P} [symbol] _{desired}^{E} is defined by user and ^{W} [symbol] ^{P}^{ₘ} is also obtained either directly from the path defined by the user or by first obtaining ^{W} [symbol] ^{P}^{ₘ} using (12) and ^{C} [symbol] ^{P}^{ₘ} from the path definition.

^{W} [symbol] ^{E}^{ₘ}=^{W} [symbol] ^{P}^{ₘ}^{P} [symbol] _{desired}^{E} (18)

At the end, it should be noted that after we obtain the new observation for ^{C} [symbol] ^{P}^{ₘ} via the ULC, the corrected pose of the end-effector with respect to the part can be calculated using:

^{P} [symbol] _{corrected}^{E}=(^{W} [symbol] ^{CC} [symbol] _{observed}^{P}^{ₘ})⁻¹(^{W} [symbol] ^{E}^{ₘ}) (19)

The introduced point-to-point path planning method is a comprehensive online approach that is based on a highly flexible path definition method, by use of which, an online correction and alignment method is applied on the pose of both the robot's end-effector and the workpiece with respect to the path and the pick and/or placement nest.

An advantageous path definition based on multiple coordinate systems is introduced and used in the proposed method that allows hierarchal transformation from the world coordinate system to the final varying coordinates defined as poses of the workpiece (part) on the path. This beneficial definition is the basis for online correction and alignment on the path as new observations from dual vision camera are obtained.

An online path planner with three correction and alignment procedures i) LBP (look before picking), ii) CPP (correct pose on path), iii) CPN (correct pose on nest) that respectively corrects and aligns the pose of a) the workpiece with respect to the robot, b) the workpiece with respect to the desired path and c) the workpiece with respect to the placement nest. Each of these three procedures can be used according to the requirements of a specific application that the robot is tasked to perform.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. An online path planner with three correction and alignment procedures comprising:
i) look before picking (LBP);
ii) correct pose on path (CPP); and
iii) correct pose on nest (CPN),
wherein each procedure respectively corrects and aligns a pose of:
a) a workpiece with respect to a robot;
b) the workpiece with respect to a desired path; and
c) the workpiece with respect to a placement nest.
